(19) United States
(12) Patent Application Publication
(10) Pub. No.: US 2026/0140732 A1
(43) Pub. Date: May 21, 2026

(54) VEHICLE CONTROL DEVICE AND VEHICLE CONTROL METHOD

(71) Applicant: TOYOTA JIDOSHA KABUSHIKI KAISHA, Toyota-shi (JP)

(72) Inventor: Hiroki ONOYAMA, Toyota-shi (JP)

(73) Assignee: TOYOTA JIDOSHA KABUSHIKI KAISHA, Toyota-shi (JP)

(21) Appl. No.: 19/335,397

(22) Filed: Sep. 22, 2025

(30) Foreign Application Priority Data
Nov. 21, 2024 (JP) 2024-203282

(51) Int. Cl. G06F 8/65; B60L 58/12

(52) U.S. Cl. CPC G06F 8/65; B60L 58/12; B60L 2270/40

(57) ABSTRACT

A vehicle control device according to one embodiment mounted on a vehicle capable of executing a process of updating a control program of an in-vehicle device through communication with an external device. An acquirer acquires information on the execution of a predetermined in-vehicle function installed in the vehicle and a remaining amount of a power supply device of the vehicle. A determiner determines whether to execute the update process based on the information on the execution of the predetermined in-vehicle function and the remaining amount of the power supply device acquired by the acquirer.

The disclosure of Japanese Patent Application No. 2024-203282 filed on Nov 21, 2024 including the specification, drawings and abstract is incorporated herein by reference in its entirety.

### BACKGROUND

### 1. Technical Field

This disclosure relates to technology used in vehicles capable of executing a process for updating the control program of in-vehicle devices through communication with external devices.

### 2. Description of Related Art

JP 2024-44264 discloses a control device that enables implementation of a software update process for an electronic control unit installed in a vehicle. This control device has a monitoring unit that monitors the storage capacity and temperature of the battery that supplies power for implementing the software update process, a determination unit that determines whether the storage capacity of the battery is equal to or greater than the first storage capacity and whether the temperature of the battery is equal to or greater than the first temperature, a control unit controls the updating process to be carried out, when the temperature of the battery at the time of starting the vehicle is less than the first temperature and the temperature of the battery is less than the second temperature, and after the vehicle has finished driving, if the determination unit determines that the storage capacity of the battery is equal to or more than the first storage capacity and the temperature of the battery is equal to or more than the first temperature.

In the technology disclosed in JP 2024-44264, if the update process is executed when a predetermined in-vehicle function is being performed, the remaining battery power may fall below the amount of power required for the update process.

### SUMMARY

A purpose of the present disclosure is to provide a technique to suppress the process of updating the control program of an in-vehicle device from stopping in the middle of the process.

A vehicle control device of one embodiment of the present disclosure. A vehicle control device mounted on a vehicle capable of executing an update process of updating a control program of an in-vehicle device through communication with an external device, the vehicle control device comprising: an acquirer that acquires information on the execution of a predetermined in-vehicle function installed in the vehicle and a remaining amount of a power supply device of the vehicle; and a determiner that determines whether to execute the update process based on the information on the execution of the predetermined in-vehicle function and the remaining amount of the power supply device acquired by the acquirer.

Another embodiment is a vehicle control method is performed by a vehicle control device mounted on a vehicle capable of executing an update process of updating a control program of an in-vehicle device through communication with an external device.

The vehicle control method comprising: acquiring information on the execution of a predetermined in-vehicle function installed in the vehicle and a remaining amount of a power supply device of the vehicle; and determining whether to execute the update process based on the acquired information on the execution of the predetermined in-vehicle function and the remaining amount of the power supply device.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows the functional structure of the example vehicle control system;

FIG. 2A and 2B shows the relationship between the remaining amount of the power supply device and the power consumption of in-vehicle functions;

FIG. 3 shows the process of determining updates based on the priority of the update;

FIG. 4 is a flowchart of the process of determining the execution of the update process.

### DETAILED DESCRIPTION

Various embodiments now will be described. The embodiments are illustrative and are not intended to be limiting.

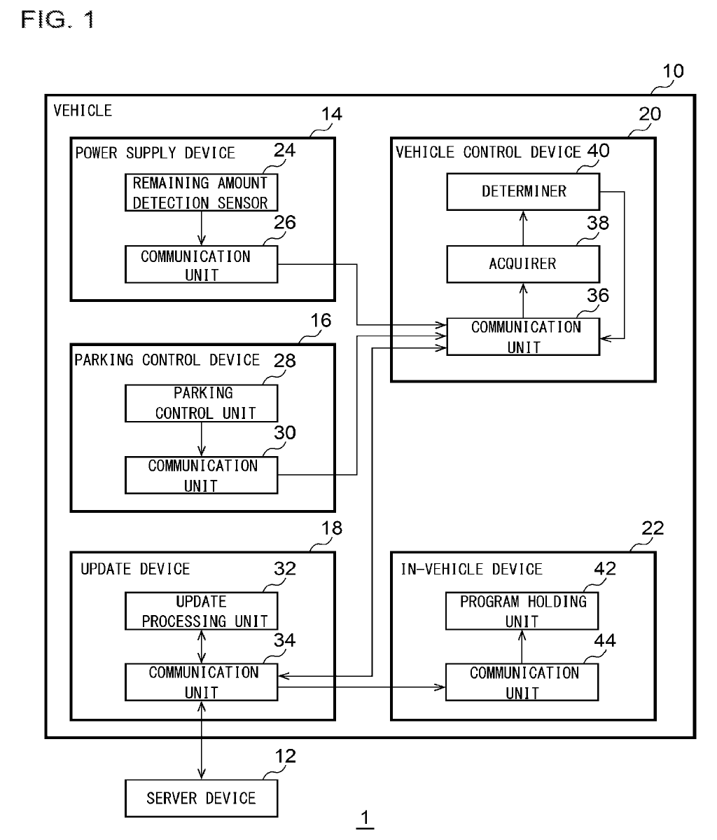

FIG. 1 shows the functional structure of the vehicle control system 1 according to an embodiment. Each function of the vehicle control system 1 can be hardware-configured with circuit blocks, memory, and other LSIs, and software-configured with system software and application programs loaded into the memory. Therefore, it is understood by those skilled in the art that each function of the vehicle control system 1 can be realized in various ways by hardware alone, software alone, or a combination thereof, and is not limited to anyone.

The vehicle control system 1 comprises a vehicle 10 and a server device 12 and is a system to update the program. The vehicle 10 and the server device 12 can communicate wirelessly over a network. Although one vehicle 10 is shown in FIG. 1, in reality, multiple vehicles 10 are connected to the server device 12. The vehicle 10 may be PHEV (Plug-in Hybrid Electric Vehicle), BEV (Battery Electric Vehicle), HEV (Hybrid Electric Vehicle), etc., and may be capable of driving autonomously and have automatic driving control functions.

The server device 12 is an external device provided outside of the vehicle 10 and maintains vehicle information for multiple vehicles 10. The vehicle information includes vehicle ID and vehicle type information. The server device 12 sends update request notifications over the air (OTA) to the plurality of vehicles 10, and distributes update files to update the control program of the in-vehicle device 22 when the update is permitted.

The update request notification includes information indicating the priority level. The information indicating the priority may be expressed, for example, in one of three levels: "high," "medium," or "low. For example, a "high" update file may correct a defect in the control program, a "medium" update file may improve security, and a "low" update file may add functionality. The update file is assigned an in-vehicle function ID indicating which in-vehicle function is the target of the update. The priority level may be replaced by an urgency level indicating the urgency of the update.

The vehicle 10 has a power supply device 14, a parking control device 16, an update device 18, a vehicle control device 20, and an in-vehicle device 22. The power supply unit 14 provides power to perform the update process and to perform certain in-vehicle functions.

The power supply device 14 has a remaining amount detection sensor 24 and a communication unit 26. The power supply device 14 is for example, a high-voltage power supply. The remaining amount detection sensor 24 detects the remaining amount of power in the power supply 14. The communication unit 26 periodically transmits information indicating the remaining amount to the vehicle control unit 20 via in-vehicle communication. The remaining amount of the power supply 14 may be the SOC (State Of Charge).

The parking control unit 16 has a parking control unit 28 and a communication unit 30. The parking control unit 28 performs assistance in parking the vehicle 10 in a predetermined parking position. Parking control unit 28 may control drive units to automatically move vehicle 10 to a set parking position. The parking function consumes a lot of power. The communication unit 30 transmits information about the execution of the parking function to the vehicle control unit 20. The information about the execution of the parking function may include information indicating whether or not the parking function is being executed, the time since the start of the execution of the parking function.

The update device 18 has an update processing unit 32 and a communication unit 34. The communication unit 34 is capable of communicating wirelessly with the server device 12. The communication unit 34 is also capable of communicating with the vehicle control unit 20 via in-vehicle communication.

When the communication unit 34 receives an update request notification from the server device 12, the communication unit 34 transmits the update request notification to the vehicle control unit 20. Update processing unit 32 receives information indicating update whether or not an update is possible from vehicle control unit 20, and communication unit 34 transmits the information indicating update availability to server device 12. If the update is possible, the server device 12 sends the update file to the update device 18.

The update processing unit 32 receives the update file from the server device 12 and executes the update processing for the in-vehicle device 22 to be updated. In the update process, the control program of the in-vehicle device 22 is updated.

The in-vehicle device 22 has in-vehicle functions that are target to updating and has a program holding unit 42 and a communication unit 44. The program holding unit 42 holds the control program for executing the in-vehicle functions. The communication unit 44 receives update instructions and update files from the updating device 18. The in-vehicle device 22 may be any of the parking control device 16, the update device 18, and the vehicle control device 20, which may also be the target of the update.

The vehicle control unit 20 may be, for example, a power ECU (electronic control unit). The vehicle control unit 20 has a communication unit 36, an acquirer 38, and a determiner 40. The communication unit 36 can communicate with the power supply unit 14, the parking control unit 16, and the update unit 18 via in-vehicle communication.

The acquiring unit 38 acquires information regarding the execution of the predetermined in-vehicle function and the remaining amount of the power supply unit 14 of the vehicle. The information regarding the execution of the predetermined in-vehicle function is information regarding the execution of the parking function transmitted from the parking control unit 16 in FIG. 1, but it is not limited to the parking function; it can be any in-vehicle function that consumes a lot of power and can be a driving support function. In other words, the parking control unit 16 can be replaced by a device that executes another in-vehicle function with high power consumption.

The determination unit 40 determines whether to execute the update process based on the information on the execution of the predetermined in-vehicle function obtained by the acquiring unit 38 and the remaining amount of the power supply unit 14. This allows determining whether the update process can be executed based on the execution status of the in-vehicle functions and the remaining amount of power supply.

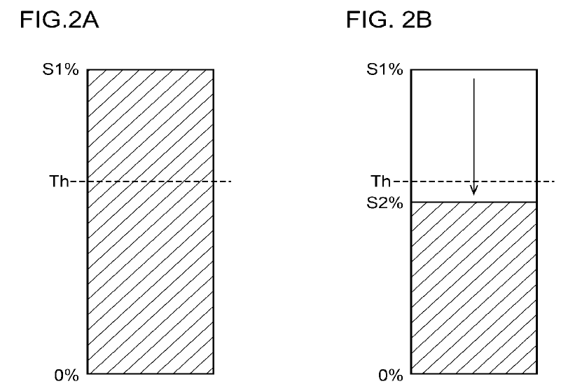

FIG. 2 illustrates the relationship between the amount of power remaining in the power supply 14 and the power consumption of in-vehicle functions. In FIG. 2A and 2B, the vertical axis indicates the remaining amount of power supply 14. The predetermined threshold value Th indicates the amount of remaining power required to execute the update process, and indicates that there is sufficient remaining power in the power supply unit 14 after the update process is performed.

In FIG. 2A, the remaining amount of power supply 14 is S1 percent, which is the amount of remaining power needed to execute the update process. Therefore, even if power is consumed in the update process, the remaining amount of power supply 14 is normally secured.

In FIG. 2B, the remaining amount of power supply 14 is consumed by the execution of in-vehicle functions and decreases from S1 percent to S2 percent. Since S2 percent is less than the threshold value Th, when the update process is executed, the remaining amount of power supply 14 is zero or near zero, thus the update process may be interrupted. Therefore, when a specific in-vehicle function is running, the determiner 40 decides not to execute the update process even if the remaining amount of the power supply unit 14 is greater than the predetermined threshold value Th. This prevents the update process from being interrupted midway due to insufficient remaining power of the power supply unit 14 when the update device 18 is executing the update process.

When the parking function is not being executed, the determiner 40 determines to execute the update process with the remaining amount of the power supply device 14 that is less than that occurring when the parking function is being executed. The determiner 40 determines the execution of the update process with the remaining amount of the power supply device 14 greater in the case where a given in-vehicle function is being performed than in the case where the in-vehicle function is not being executed. When the predetermined in-vehicle function is being executed, the update process is executed when the remaining amount of the power supply unit 14 is greater than the first remaining amount, which is greater than the second remaining amount used when the predetermined in-vehicle function is not being performed. If the predetermined in-vehicle function is not being performed, the update process is executed if the remaining amount of the power supply unit 14 is greater than or equal to the second remaining amount. The second remaining amount is set by the power consumption of the predetermined in-vehicle function and the power consumption of the update process.

The determiner 40 may estimate the remaining amount of the power supply unit 14 when the update process is executed based on the information about the execution of the predetermined in-vehicle function and the remaining amount of the power supply unit 14, and determine whether to execute the update process when the estimated remaining amount of the power supply unit 14 is above a predetermined value.

Return to FIG. 1. The acquiring section 38 acquires an update request notification that includes information regarding the execution of the predetermined in-vehicle function and the remaining amount of the power supply device 14 as well as information indicating the priority level of the update. The determiner 40 determines whether to execute the update process based on the information regarding the execution of the predetermined in-vehicle function, the remaining amount of the power supply unit 14, and the information indicating the priority level of the update. If the priority of the update is high, the update process is more likely to be executed.

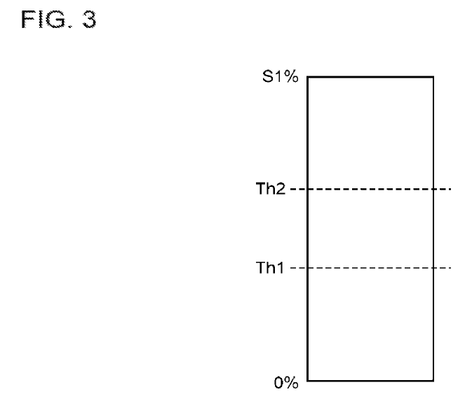

FIG. 3 illustrates the decision process for updating according to the priority level of updating. The vertical axis shown in FIG. 3 indicates the remaining amount of power supply 14. The first threshold value Th1 and the second threshold value Th2 indicate the amount of remaining power required to execute the updating process according to the priority of updating. When the priority level is "high," it is referred to as the first priority level. When the priority level is "medium" or "low," it is referred to as the second priority level.

The determiner 40 decides to execute the update process when the priority level of the update is the first priority level and the remaining amount is equal to or greater than the predetermined first threshold value Th1. The determiner 40 decides not to execute the updating process when the priority of updating is the first priority and the remaining amount is not less than the predetermined first threshold Th1. The determiner 40 decides to execute the update process when the priority of the update is a second priority lower than the first priority and the remaining amount is higher than the second threshold Th2, which is higher than the first threshold Th1. The determiner 40 decides not to execute the update process when the priority of the update is the second priority and the remaining amount is not higher than the second threshold Th2.

As a result, when the priority level is relatively high, the update process is executed with priority even if there is a possibility that the remaining amount of the power supply unit 14 will be close to zero after the update process. On the other hand, when the priority is relatively low, the update process is executed when there is enough remaining power in the power supply unit 14 after the update process. In other words, if the update process is executed at the first threshold value Th1, the remaining amount of the power supply unit 14 may decrease to the minimum amount required to use the vehicle 10.

In FIG. 3, the first threshold value Th may correspond to a priority level of "medium" and the second threshold value Th may correspond to a priority level of "low". In addition, the threshold value is not limited to a two-level setting, but may be set in three levels.

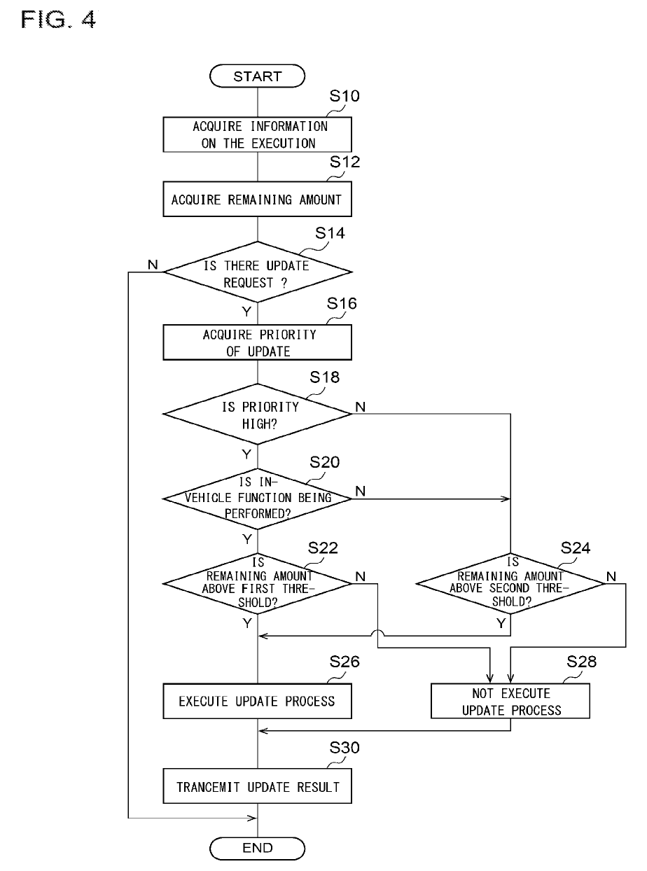

FIG. 4 is a flowchart of the process of determining the execution of the update process. The acquisition unit 38 of the vehicle control unit 20 acquires information regarding the execution of the parking function from the parking control unit 16 in order to ascertain whether the parking function is being performed (S10). The acquisition unit 38 acquires the remaining power from the power supply unit 14 (S12).

The determination unit 40 determines whether there is an update request notification from the server device 12 (S14). If there is no update request notification (N in S14), this process is terminated. If there is an update request notification (Y in S14), the determiner 40 obtains the priority of the update (S16).

The determiner 40 determines whether the priority of the update is the highest (S18). If the priority of the update is highest (Y in S18), the determiner 40 determines whether the predetermined in-vehicle function is being performed (S20). If the predetermined in-vehicle function is being performed (Y in S20), the determiner 40 determines whether the remaining amount of the power supply unit 14 is above the predetermined first threshold (S22).

If the remaining amount of the power supply unit 14 is above the predetermined first threshold (Y in S22), the determiner 40 determines that the update process can be executed (S26) and transmits the decision result to the update unit 18 (S30). If the remaining amount of the power supply 14 is not more than the predetermined first threshold (N in S22), the decision unit 40 determines that the update process is not executable (S28) and transmits the decision result to the updating device 18 (S30).

If the priority is not the highest (N in S18), the determiner 40 determines whether the remaining amount of the power supply unit 14 is above the predetermined second threshold (S24). The second threshold is greater than the first threshold. If the remaining amount of the power supply unit 14 is greater than or equal to the predetermined second threshold (Y in S24), the determiner 40 determines that the update process can be performed (S26) and transmits the decision result to the update device 18 (S30). If the remaining amount of the power supply 14 is not more than the predetermined second threshold (N in S24), the determiner 40 determines that the update process is not executable (S28) and transmits the decision result to the updating device 18 (S30).

If the predetermined in-vehicle function is not being performed (N in S20), the determiner 40 determines whether the remaining amount of the power supply unit 14 is above the predetermined second threshold (S24). The second threshold in the case of N in S20 may be different from the second threshold used in the case of N in S18. If the remaining amount of the power supply 14 is greater than or equal to the predetermined second threshold (Y in S24), the determiner 40 determines that the update process can be performed (S26), and if the remaining amount of the power supply 14 is not greater than the predetermined second threshold (N in S24), the determiner 40 determines that the update process cannot be performed (S28).

The present disclosure has been described based on examples. The present disclosure is not limited to the examples described above, and various design changes and other variations can be made based on the knowledge of those skilled in the art.

The example shows a situation in which the updating device 18 and the vehicle control unit 20 are different ECUs, but this is not limited to this situation and they can be the same ECU.

What is claimed is:

1. A vehicle control device mounted on a vehicle capable of executing an update process of updating a control program of an in-vehicle device through communication with an external device, the vehicle control device comprising:
an acquirer that acquires information on the execution of a predetermined in-vehicle function installed in the vehicle and a remaining amount of a power supply device of the vehicle; and
a determiner that determines whether to execute the update process based on the information on the execution of the predetermined in-vehicle function and the remaining amount of the power supply device acquired by the acquirer.

2. The vehicle control device of claim 1,
Wherein a control program update request notification sent from the external device to the vehicle control device includes information indicating the priority level of the update, and
wherein the acquirer acquires the information indicating the priority level of the update,
wherein the determiner determines whether to execute the update process based on the information on the execution of the predetermined in-vehicle function, the remaining power of the power supply device and the information indicating the priority level of the update.

3. The vehicle control device of claim 1,
wherein the determiner determines to execute the update process when the priority level of the update is a first priority and the remaining amount of the power supply device is greater than or equal to a predetermined first threshold value, and
wherein the determiner determines to execute the update process when the priority level of the update is a second priority lower than the first priority and the remaining amount of the power supply device is higher than a second threshold higher than the first threshold.

4. The vehicle control device of claim 1,
wherein the acquirer acquires information on the execution of a parking function as the predetermined in-vehicle function,
when the parking function is not being executed, the determiner determines to execute the update process with a remaining amount of the power supply device that is less than that occurring when the parking function is being executed.

5. A vehicle control method performed by a vehicle control device mounted on a vehicle capable of executing an update process of updating a control program of an in-vehicle device through communication with an external device, the vehicle control method comprising:
acquiring information on the execution of a predetermined in-vehicle function installed in the vehicle and a remaining amount of a power supply device of the vehicle; and
determining whether to execute the update process based on the acquired information on the execution of the predetermined in-vehicle function and the remaining amount of the power supply device.
